(19) United States
(12) Patent Application Publication
(10) Pub. No.: US 2026/0322843 A1
(43) Pub. Date: Oct. 15, 2026

(54) APPARATUS AND METHOD FOR ANALYZING NETWORK TRAFFIC

(71) Applicant: ELECTRONICS AND TELECOMMUNICATIONS RESEARCH INSTITUTE, Daejeon (KR)

(72) Inventors: Jae Hak Yu, Daejeon (KR); Ki Jong Koo, Daejeon (KR); Dae Sung Moon, Daejeon (KR); Yang Seo Choi, Daejeon (KR)

(21) Appl. No.: 19/643,194

(22) Filed: Apr. 9, 2026

(30) Foreign Application Priority Data
Apr. 11, 2025 (KR) 10-2025-0047227

(51) Int. Cl. H04L 9/40

(52) U.S. Cl. CPC H04L 63/1425; H04L 63/0428

(57) ABSTRACT

The present disclosure relates to an apparatus and a method for analyzing network traffic. A method for analyzing network traffic according to one aspect of the present disclosure may include: obtaining encrypted network traffic from a network; selecting n packets (n is an integer greater than 0) from the encrypted network traffic; extracting multi-modal feature information from each of the n packets, wherein the multi-modal feature information includes one or more header fields and a k-byte payload (k is an integer greater than 0); generating a dataset based on the multi-modal feature information for the n packets; and performing an analysis of the network traffic based on the dataset.

### CROSS-REFERENCE TO RELATED APPLICATION

This application claims the benefit of earlier filing date and right of priority to Korean Application No. 10-2025-0047227, filed on Apr. 11, 2025, the contents of which are all hereby incorporated by reference herein in their entirety.

### TECHNICAL FIELD

The present disclosure relates to a method for analyzing network traffic using encrypted network traffic and, and an apparatus therefor.

### BACKGROUND

With the increase in encrypted traffic, the majority of internet traffic utilizes encryption protocols such as HTTPS (Hypertext Transfer Protocol Secure). While encrypted traffic using such protocols can protect personal information and data, it simultaneously allows attackers to infiltrate with malicious or abnormal behavior or specific objectives, and these attempts to bypass the system make detection difficult. Traditionally, network security systems (e.g., Intrusion Detection Systems (IDS) and Intrusion Prevention Systems (IPS)) have detected malicious activity by analyzing packet contents and pre-defining signatures or regular expressions. However, since packet contents cannot be verified in encrypted traffic, the effectiveness of these existing methods is steadily declining.

Recently, machine learning, statistical approaches, and deep learning models are being utilized for stable network system operation and Quality of Service (QoS) by detecting attack behaviors or classifying applications within encrypted traffic. Representative examples include 5-tuples (source IP address, source port, destination IP address, destination port, and protocol) that include a port. These represent network traffic as a simple set of attributes, facilitating data processing and making them suitable for statistical and machine learning-based attack detection models. Furthermore, they offer fast computation speeds due to low computational costs and the elimination of the need to analyze and utilize complex payloads. However, they have limitations; since the payload is excluded, they are vulnerable to detecting application layer attacks (such as SQL injection and XSS) and it is difficult to obtain meaningful information from encrypted traffic. Additionally, there is a high probability of false positives (misclassifying legitimate traffic as attack behavior), and performance guarantees are difficult in current network environments due to the application of dynamic ports or Network Address Translation (NAT) protocol technologies.

Fingerprinting methodologies attempt attack detection and application classification by analyzing metadata and behavioral patterns in encrypted traffic. Since the payload is invisible in encrypted data, features such as packet size, transmission interval, traffic direction, and session length are utilized to distinguish between normal and abnormal traffic. This fingerprinting method has the advantage of detecting attacks through behavior-based features (fingerprints) even in encrypted traffic such as TLS (Transport Layer Security) or SSL (Secure Sockets Layer), and minimizes concerns regarding privacy infringement because it analyzes patterns solely without payload decryption. However, there is a high possibility of false positives as similar fingerprints can occur in normal traffic, and it is impossible to distinguish between normal and abnormal encrypted traffic that possesses similar patterns. Furthermore, while it may demonstrate good performance on public datasets, patterns can be distorted or altered by real-world network environments, latency, and traffic fluctuations; thus, it has clear limitations in classifying new attack behaviors or applications that deviate from predefined patterns.

Deep Packet Inspection (DPI) is widely used to detect anomalies or attacks, or to classify applications, by analyzing the packet headers and payloads of network traffic. When applying DPI to encrypted traffic, since the payload cannot be decrypted, it is used to classify anomalies, attacks, or specific service types or applications within the encrypted traffic by comprehensively utilizing header information and characteristics of the encryption protocol (e.g., TLS handshake, certificate information, session length, or packet size distribution). It primarily uses header information (IP address, sequence number, port number, protocol, offset, packet length, etc.), TLS handshake and encryption protocol session negotiation (establishment) information, and packet flow characteristics such as transmission intervals or upload/download ratios. However, this DPI method has the disadvantage of consuming a lot of resources because it must inspect all packets, and it is difficult to detect if an attacker disguises traffic patterns or makes encrypted traffic more irregular. Additionally, it has the fatal disadvantage that the use of DPI in encrypted traffic is further restricted due to the minimization of metadata exposure in recent encryption protocols such as TLS 1.3 and QUIC (Quick UDP Internet Connections).

Furthermore, machine learning methodologies detect anomalies by learning normal and attack patterns based on traffic metadata (packet size, transmission interval, session length, IP address, sequence number, protocol, offset, etc.), and techniques such as supervised learning, unsupervised learning, and reinforcement learning are being applied. While these methods offer the advantage of real-time detection and the ability to detect unknown attack types (e.g., zero-day attacks), they require a dataset covering a sufficient number of attack types, carry the risk of false positives, and entail the cost burden of retraining or updating models whenever the network environment changes. Deep learning-based detection methods automatically extract complex features such as traffic flow characteristics, packet sequences, and sizes, and then utilize various architectures—including Convolutional Neural Networks (CNN), Recurrent Neural Networks (RNN), LSTM, and Transformers—to apply attack detection or classification by application. These deep learning models can perform automated feature extraction, achieve relatively high detection performance, and detect new types of attacks that have not been learned or observed (e.g., zero-day attacks). However, they have disadvantages such as high computational costs and energy consumption due to the use of GPUS (Graphic Processing Units), biased models dependent on the training dataset, relatively long training times and increased costs during retraining, and difficulties in interpretation and analysis due to their black-box nature.

### SUMMARY

A technical object of the present disclosure is to provide a method and apparatus for analyzing network traffic, such as detecting attack activities or classifying traffic by application, by utilizing multimodal features in encrypted network traffic.

The technical objects to be achieved by the present disclosure are not limited to the above-described technical objects, and other technical objects which are not described herein will be clearly understood by those skilled in the pertinent art from the following description.

A method for analyzing network traffic according to one aspect of the present disclosure may include: obtaining encrypted network traffic from a network; selecting n packets (n is an integer greater than 0) from the encrypted network traffic; extracting multi-modal feature information from each of the n packets, wherein the multi-modal feature information includes one or more header fields and a k-byte payload (k is an integer greater than 0); generating a dataset based on the multi-modal feature information for the n packets; and performing an analysis of the network traffic based on the dataset.

An apparatus for analyzing network traffic according to an additional aspect of the present disclosure may include: at least one processor; and at least one memory operably connected to the at least one processor and storing instructions that, when executed by the one or more processors, cause the apparatus to perform operations. The operations may include: obtaining encrypted network traffic from a network; selecting n packets (n is an integer greater than 0) from the encrypted network traffic; extracting multi-modal feature information from each of the n packets, wherein the multi-modal feature information includes one or more header fields and a k-byte payload (k is an integer greater than 0); generating a dataset based on the multi-modal feature information for the n packets; and performing an analysis of the network traffic based on the dataset.

At least one non-transitory computer-readable medium storing at least one instruction according to an additional aspect of the present invention, wherein the at least one instruction executable by at least one processor may control an apparatus for analyzing network traffic to: obtain encrypted network traffic from a network; select n packets (n is an integer greater than 0) from the encrypted network traffic; extract multi-modal feature information from each of the n packets, wherein the multi-modal feature information includes one or more header fields and a k-byte payload (k is an integer greater than 0); generate a dataset based on the multi-modal feature information for the n packets; and perform an analysis of the network traffic based on the dataset.

Preferably, a value of the n and a value of the k may be determined based on a configuration for analyzing traffic of the network.

Preferably, the dataset may be generated by sequentially concatenating the multi-modal feature information for each of the n packets.

Preferably, the dataset may be generated by sequentially concatenating one or more header fields for each of the n packets, and subsequently concatenating the k-byte payloads for each of the n packets.

Preferably, the n packets may be selected per session or flow.

Preferably, the n packets initially generated per the session or the flow may be selected.

Preferably, in generating the dataset, the multi-modal feature information for each of the n packets may have same length by zero-padding for a payload portion of a packet without a payload among the n packets.

Preferably, the one or more header fields may comprise at least one of an internet protocol (IP) version, an IP header length, a type of service (TOS), an IP fragment offset, an IP protocol, a transmission control protocol (TCP) offset, TCP flags, a TCP window, a TCP urgent pointer, and a user datagram protocol (UDP) length.

Preferably, an analysis model for analyzing traffic of the network may be pre-trained using the dataset, and the analysis model may be fine-tuned according to a type of analyzing traffic of the network.

According to an embodiment of the present invention, network traffic can be analyzed using encrypted network traffic to detect attacks (commercial activities) or classify them by application.

In addition, according to an embodiment of the present invention, by extracting and generating various numbers of packets and payloads included in each packet, unique patterns or identification information inherent in attack behavior or application-specific handshake processes and cryptographic protocol negotiation processes are configured as multimodal features, thereby improving the generalization capability of attack (abnormal behavior) detection or application-specific classification models and enabling adaptive utilization in actual network environments.

In addition, according to an embodiment of the present invention, by fine-tuning an analysis model for attack detection, malicious behavior detection, or application-specific classification depending on the purpose of analyzing network traffic, it is possible to improve the accuracy of attack (abnormal behavior) detection and reduce the false positive rate in real time, and to improve the application-specific classification and prediction of encrypted traffic in real time.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a network traffic analysis system according to an embodiment of the present invention.

FIG. 2 illustrates a data processing module according to an embodiment of the present invention.

FIG. 3 illustrates an operation of selecting and extracting multimodal features extracted from selected n packets according to an embodiment of the present invention.

FIG. 4 illustrates multimodal feature information for each packet according to an embodiment of the present invention.

FIG. 5 illustrates a dataset composed of multimodal feature information according to an embodiment of the present invention.

FIG. 6 illustrates a dataset composed of multimodal feature information for each flow according to an embodiment of the present invention.

FIG. 7 illustrates a dataset composed of multimodal feature information for each flow according to an embodiment of the present invention.

FIG. 8 illustrates a method for analyzing network traffic according to an embodiment of the present invention.

FIG. 9 is a block diagram of a network traffic analysis device according to one embodiment of the present invention.

### DETAILED DESCRIPTION

Since the present disclosure can make various changes and have various embodiments, specific embodiments will be illustrated in the drawings and described in detail in the detailed description. However, this is not intended to limit the present disclosure to specific embodiments, and should be understood to include all changes, equivalents, and substitutes included in the feature and technical scope of the present disclosure. Similar reference numbers in the drawings refer to identical or similar functions across various aspects. The shapes and sizes of elements in the drawings may be exaggerated for clearer explanation. For a detailed description of the exemplary embodiments described below, refer to the accompanying drawings, which illustrate specific embodiments by way of example. These embodiments are described in sufficient detail to enable those skilled in the art to practice the embodiments. It should be understood that the various embodiments are different from one another but are not necessarily mutually exclusive. For example, specific shapes, structures and characteristics described herein with respect to one embodiment may be implemented in other embodiments without departing from the spirit and scope of the disclosure. Additionally, it should be understood that the position or arrangement of individual components within each disclosed embodiment may be changed without departing from the spirit and scope of the embodiment. Accordingly, the detailed description that follows is not to be intended in a limiting sense, and the scope of the exemplary embodiments is limited only by the appended claims, together with all equivalents to what those claims assert if properly described.

In the present disclosure, terms such as first, second, etc. may be used to describe various components, but the components should not be limited by the terms. The above terms are used only for the purpose of distinguishing one component from another. For example, a first component may be referred to as a second component, and similarly, the second component may be referred to as a first component without departing from the scope of the present disclosure. The term “and/or” includes any of a plurality of related stated items or a combination of a plurality of related stated items.

When a component of the present disclosure is referred to as being “connected” or “accessed” to another component, it may be directly connected or connected to the other component, but other components may exist in between. It must be understood that it may be possible. On the other hand, when it is mentioned that a component is “directly connected” or “directly accessed” to another component, it should be understood that there are no other components in between.

The components appearing in the embodiments of the present disclosure are shown independently to represent different characteristic functions, and do not mean that each component is comprised of separate hardware or one software component. That is, each component is listed and included as a separate component for convenience of explanation, and at least two of each component can be combined to form one component, or one component can be divided into a plurality of components to perform a function, and each of these components can be divided into a plurality of components. Integrated embodiments and separate embodiments of the constituent parts are also included in the scope of the present disclosure as long as they do not deviate from the essence of the present disclosure.

The terms used in this disclosure are only used to describe specific embodiments and are not intended to limit the disclosure. Singular expressions include plural expressions unless the context clearly dictates otherwise. In the present disclosure, terms such as “comprise” or “have” are intended to designate the presence of features, numbers, steps, operations, components, parts, or combinations thereof described in the specification, but are not intended to indicate the presence of one or more other features. It should be understood that this does not exclude in advance the possibility of the existence or addition of elements, numbers, steps, operations, components, parts, or combinations thereof. In other words, the description of “including” a specific configuration in this disclosure does not exclude configurations other than the configuration, and means that additional configurations may be included in the scope of the implementation of the disclosure or the technical feature of the disclosure.

Some of the components of the present disclosure may not be essential components that perform essential functions in the present disclosure, but may simply be optional components to improve performance. The present disclosure can be implemented by including only essential components for implementing the essence of the present disclosure, excluding components used only to improve performance, and a structure that includes only essential components excluding optional components used only to improve performance is also included in the scope of rights of this disclosure.

Hereinafter, embodiments of the present disclosure will be described in detail with reference to the drawings. In describing the embodiments of the present specification, if it is determined that a detailed description of a related known configuration or function may obscure the gist of the present specification, the detailed description will be omitted, and the same reference numerals will be used for the same components in the drawings. Redundant descriptions of the same components are omitted.

The present invention proposes a method for detecting attack behavior and classifying applications using multimodal features in encrypted traffic, based on the BERT (Bidirectional Encoder Representations from Transformers) model, which is a natural language processing model capable of understanding context bidirectionally based on an encoder of the Transformer architecture and exhibits excellent performance in various natural language processing tasks.

Specifically, the invention aims to provide a method and apparatus capable of performing pre-training with header field information of n packets (n is an integer greater than 0) selected at the flow (or session) unit of encrypted traffic and k (bytes) of payload information, and to perform detection of attacks (abnormal behavior) in encrypted traffic or classification of encrypted traffic applications as described in the example of the purpose, and to fine-tune the method.

The present invention addresses the limitations of prior studies or inventions that construct datasets by using only the metadata of a single packet or by extracting packet payloads of a fixed size (e.g., 100 bytes, 784 bytes, 1500 bytes, etc.). Since datasets extracted and preprocessed with such fixed sizes may contain characteristics sensitive to the experimental environment for data collection, it is difficult to guarantee their performance when applied to network topologies or real-world environments. To overcome these limitations, the present invention allows for the extraction and generation of varying numbers of packets included in a flow (or session unit) and the payloads contained within them, varying by k bytes, when constructing a dataset. By extracting a variety of packet numbers and payload sizes to construct the dataset, various characteristics and patterns can be extracted from the data, thereby maximizing the generalization capabilities of detection or classification models. Furthermore, by configuring a variety of selected packet numbers and payload sizes, learning is possible across diverse network environments and types of encrypted traffic, ensuring the universality and high performance of detection or classification models even in new network environments. Additionally, because the model is pre-trained and fine-tuned using data consisting of various datasets from encrypted traffic, it has the advantage of being able to detect new attack types not found in the pre-training and maintaining robust performance even against quality degradation occurring in specific network environments.

Finally, the proposed model of the present invention is designed to maintain the advantages of the BERT model while not infringing upon user privacy because it does not decrypt the payload itself even when analyzing encrypted traffic. In the attack behavior detection and application classification method of the present invention, a dataset or sentence (sequence, sentence) for pre-training and fine-tuning the BERT model is constructed from n packets, including the handshake prior to encryption, cryptographic protocol negotiation information, and unencrypted payload areas even after the formation of an encryption channel (e.g., TLS Content Type area data, QUIC SCID (Source Connection ID)/DCID (Destination Connection ID) areas, etc.). By doing so, normal encrypted traffic and abnormal traffic (e.g., attacks, data leakage, malware) can be clearly identified. Furthermore, by using sentences (sequences) composed of multimodal features to execute purpose-specific attack detection or application classification through the fine-tuning of the BERT model, it is possible to apply the method to actual network environments.

The present invention proposes a system that extracts and combines multimodal features (e.g., field information of a packet header and payload) from each packet in a flow or session unit from encrypted network traffic, while utilizing features of handshake and cryptographic protocol negotiation in encrypted traffic. More specifically, the invention proposes a method of selecting n packets (where n is an integer greater than 0) in a flow or session unit that is pre-configured (e.g., by a system or by a user), extracting field information of a header and a payload of k bytes in length from the n packets to generate a dataset with various combinations of multimodal features, and then performing network analysis based on the variously configured datasets. More specifically, a method and an implementation device are proposed that can perform real-time network analysis (e.g., detection of attacks (abnormal behavior) and classification and prediction by application) by pre-training a BERT model based on a diverse dataset and fine-tuning it according to the purpose of use (i.e., the purpose of network analysis), for example, for attack detection or malicious behavior detection, classification of cryptographic traffic service types, or classification by application.

Hereinafter, the configuration of the present invention will be described in detail with reference to the attached drawings.

Hereinafter, the present disclosure mainly describes a method for performing network traffic analysis based on a BERT model, but the present invention is not necessarily limited thereto and may perform network traffic analysis based on other models.

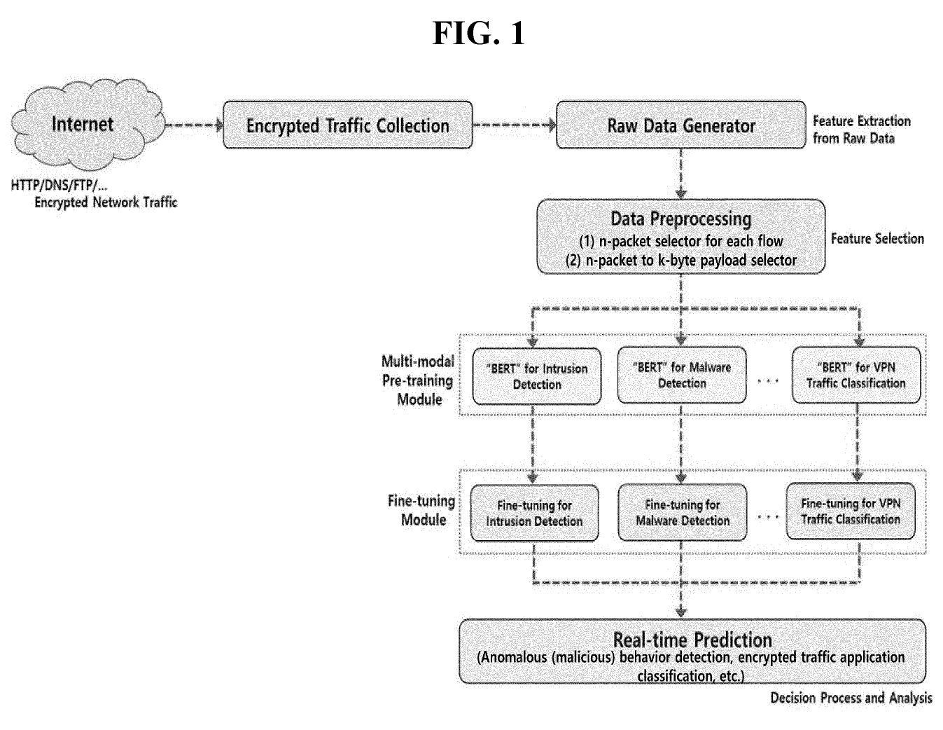

FIG. 1 illustrates a network traffic analysis system according to an embodiment of the present invention.

FIG. 1 illustrates a BERT-based network traffic analysis system proposed in the present invention. Specifically, it illustrates a device/module and procedure that extracts multimodal features (e.g., metadata and payload) from n packets in the form of flows (or sessions) from encrypted traffic, and detects attacks (abnormal/malicious behavior) and classifies them by application through pre-training and fine-tuning learning according to the purpose of network traffic analysis.

In the present disclosure, a flow may refer to a series of packets flowing between the same sender and receiver, and a session may refer to a connection formed between devices. In other words, multiple flows may be exchanged between devices while a session is maintained.

Additionally, a packet may refer to a unit for transmitting and receiving data and may be composed of a header including metadata such as the IP (internet protocol) addresses and port numbers of the sender and receiver, a payload corresponding to the content of the data actually transmitted, and a trailer including additional information such as error detection codes.

The network traffic analysis system of the present invention comprises: an encrypted traffic collection module that collects encrypted network traffic used on the Internet (e.g., HTTP (Hypertext Transfer Protocol), DNS (domain name service), FTP (file transfer protocol), etc.); a raw data generator module that extracts and generates the ‘entire set’ of features, such as header field values and payloads of packets per flow, from the collected raw data; a data processing module that constructs a data set (i.e., sentence/sequence) by extracting selected header field information from n packets pre-configured for each generated flow and a payload of k bytes for each packet; a multi-modal pre-training module that performs data pre-training using a data set composed of multimodal features; a fine-tuning module that performs fine-tuning learning according to the purpose (e.g., attack detection, anomaly detection, application classification, etc.) for each data set; and attack (or anomaly) detection according to the purpose of network traffic analysis. It can be configured to include a real-time prediction module that provides application-specific classification or prediction results.

For example, the Encrypted Traffic Collection module in FIG. 1 can save encrypted network traffic used in an internet environment as a Packet Capture (PCAP) or Packet Capture Next Generation (PCAPNG) file at a server or router location for capturing/collecting encrypted network traffic. For the convenience of the following explanation, the PCAP/PCAPNG file format is mainly described, but this is merely an example. That is, the network traffic analysis system according to the present invention is not limited thereto and can capture packets circulating in a network environment at a designated location in a file format using a specific tool (e.g., a packet capture tool such as TCPDUMP). Such PCAP or PCAPNG files may include information such as the address and port number between the sender and receiver, packet sequence or number, protocol, and the number and time of packets received between the sender and receiver.

The raw data generator module performs the function of extracting and generating packet sequence information, IP (Internet Protocol)/TCP (Transmission Control Protocol)/UDP (User Datagram Protocol) header fields and option values, and payload values for each packet of the corresponding PCAP or PCAPNG file.

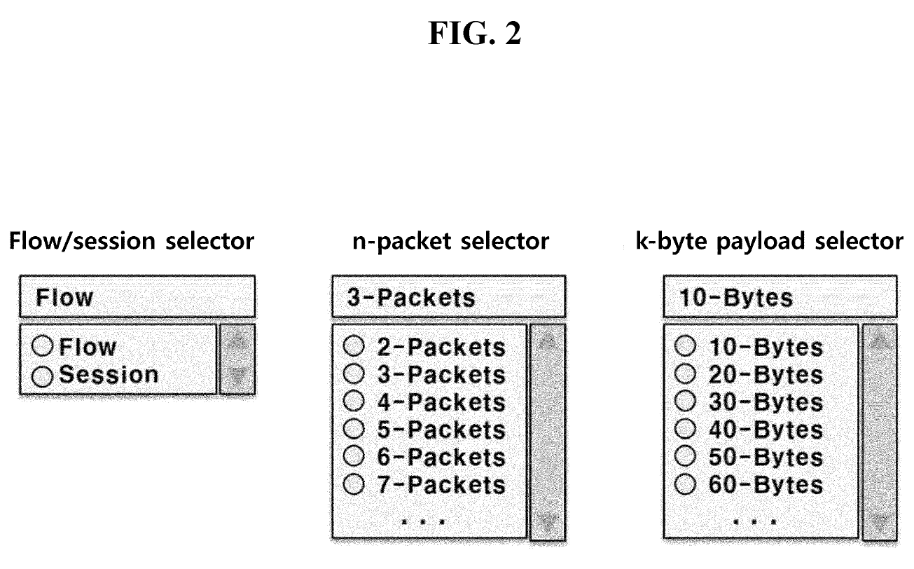

The data processing module will be explained in detail with reference to FIG. 2.

FIG. 2 illustrates a data processing module according to an embodiment of the present invention.

Referring to FIG. 2, a flow/session selector that selects whether n packets are extracted as a unit of flow or session, a data processing (preprocessing) module, an n-packet selector that determines how many packets to select per flow, and a k-byte payload selector that determines how many bytes of payload to extract from the n packets are exemplified.

In other words, the data processing module according to the present invention can variably select the selection/decision of the above selectors in a network traffic analysis system based on the purpose or application field of network traffic analysis or various network environments, and can also variably select the selection/decision of the above selectors based on input from a user, as shown in the example of FIG. 2.

As described above, the data processing module can select the number of packets to be extracted and the bytes of the payload per flow or session, and construct a dataset (sentence or sequence) consisting of multimodal features for BERT pre-training and fine-tuning.

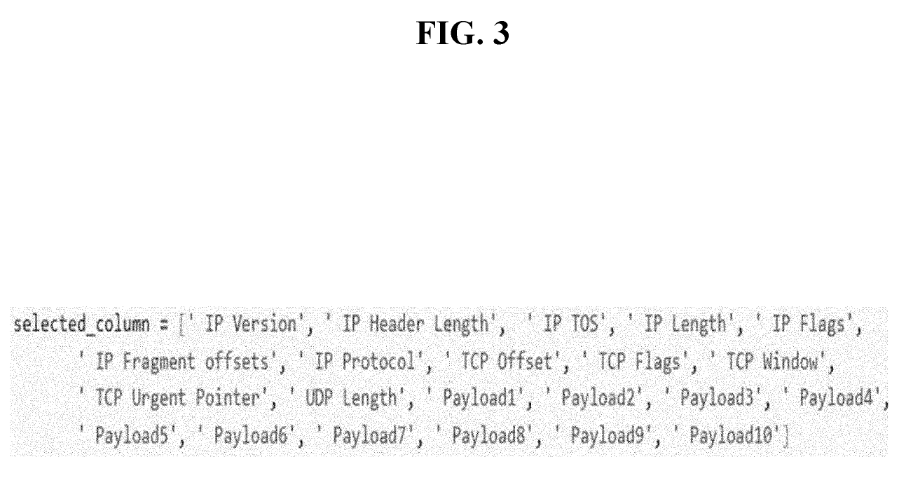

FIG. 3 illustrates an operation of selecting and extracting multimodal features extracted from selected n packets according to an embodiment of the present invention.

FIG. 3 is an example of selecting and extracting 12 header field feature information (IP version, IP header length, IP type of service (TOS), IP fragment offsets, IP protocol, TCP offset, TCP flags, TCP window, TCP urgent pointer, UDP length) and 10 payloads (i.e., payloads 1 to 10) for each packet selected by the n-packet selector (for example, 20 bytes; since the payload of traffic encrypted with TLS and QUIC is represented as a 2-byte hexadecimal number, the 10 payloads correspond to a total of 20 bytes).

The feature vectors (columns) (selected_column) exemplified in FIG. 3 are examples for explaining the present invention, and the proposed method of the present invention is not limited thereto.

Referring to FIG. 3, only 12 features can be extracted and selected without using all features of the IP/TCP/UDP header fields. The reason for not using all IP/TCP/UDP header fields as metadata is that they can be affected by network configuration environments or simulation environments during the traffic collection process. For example, regarding the 5-tuple (IP Source, IP Destination, Source Port, Destination Port, Protocol), the source and destination IPs may change if network traffic is transmitted through different paths depending on the location where encrypted traffic is collected. Additionally, the 5-tuple may change as IP addresses or port numbers may change due to NAT (Network Address Translation). Furthermore, since the 5-tuple value varies depending on how an application uses specific protocols such as TCP/UDP, it is not appropriate to use it as a generalized identification feature for attack detection or application-specific classification.

In addition, the Sequence Number field value of the TCP protocol is also randomly set as an initial value by the sending side, and since this value may vary depending on environment settings (e.g., operating system, network driver), these features are excluded, and only the 12 header fields (IP/TCP/UDP header fields, metadata) as shown in FIG. 3 can be selected. Furthermore, the value or meaning determined during the process of creating and negotiating the encryption channel before the encryption traffic is generated can be utilized as is. Accordingly, in the present invention, the selection may be limited to n packets of the packets initially generated in each flow, and the BERT model dataset (or sentence, sequence) can be constructed by extracting only up to k bytes of payload information included therein. Here, instead of using only a payload of a fixed size, a dataset (or sentence, sequence) with multimodal features configured by determining a dynamic (i.e., variable) number of packets and payload size can be used. By doing so, even for the same purpose (e.g., intrusion detection), pre-training and fine-tuning can be applied to multimodal datasets with more accurate detection rates and lower false positive rates.

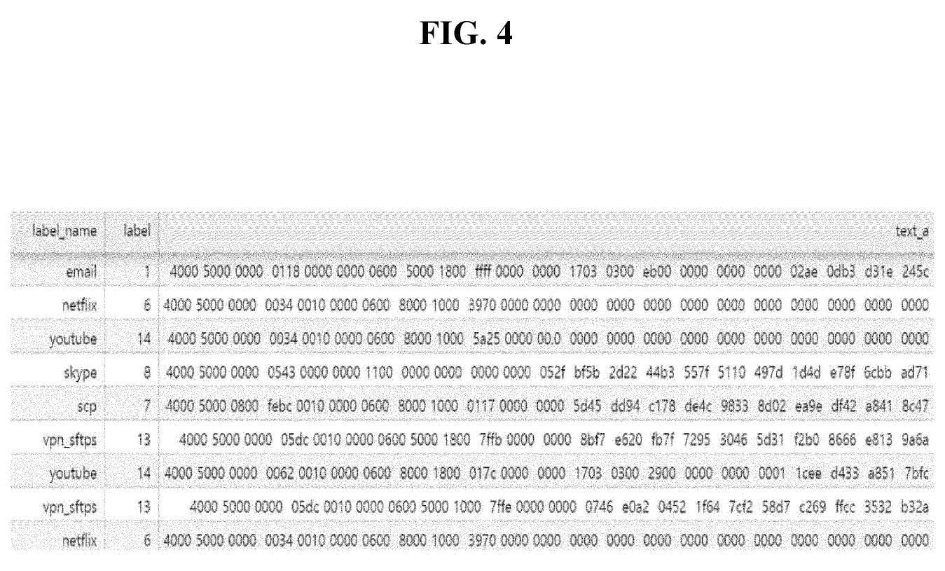

FIG. 4 illustrates multimodal feature information for each packet according to an embodiment of the present invention.

FIG. 4 illustrates multimodal feature information (or values) for each individual packet selected and extracted in FIG. 3, and each packet may consist of 12 header field information (values) of IP/TCP/UDP and a 20-byte payload (or payload value).

Here, for packets without a payload value, the corresponding payload portion may be zero-padding with a 2-byte value of 0000, which is to complete a sentence (sequence) composed of features in the BERT model.

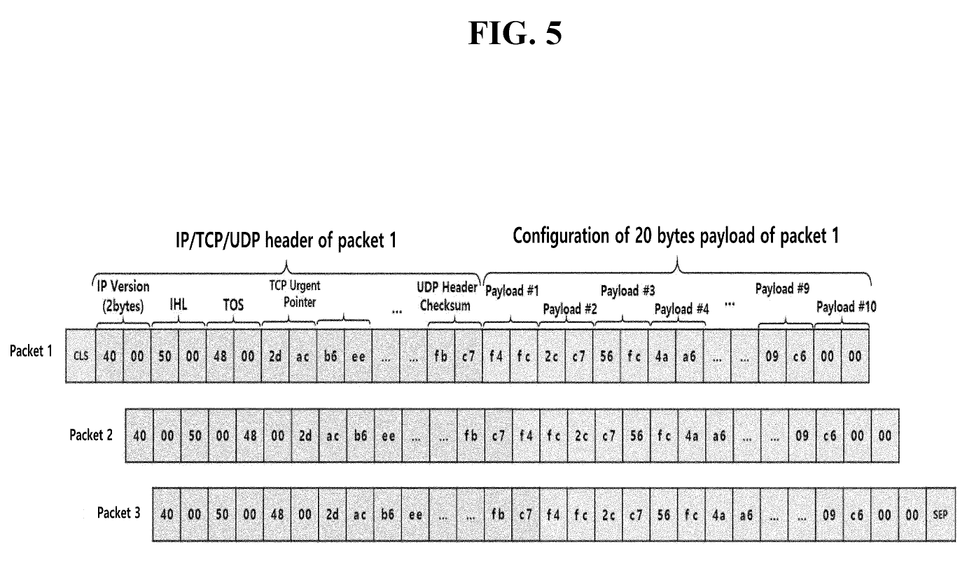

FIG. 5 illustrates a dataset composed of multimodal feature information according to an embodiment of the present invention.

FIG. 5 illustrates an example of multimodal feature selection and extraction through the selection of three packets per flow, with a 20-byte payload for each packet. Since three packets and a 20-byte payload were selected for each flow, the length of the dataset (i.e., the sentence (sequence) of the BERT model) corresponds to a total of 132 bytes.

More specifically, the header field per packet consists of 12 features, each composed of 2 bytes, resulting in a size (length) of 24 bytes. Since 10 features were selected for the payload, it becomes 20 bytes in hexadecimal representation. In other words, each packet consists of 44 bytes, and in FIG. 5, since it is 3 packets * 44 bytes, the dataset (or sentence, sequence) has a total length of 132 bytes.

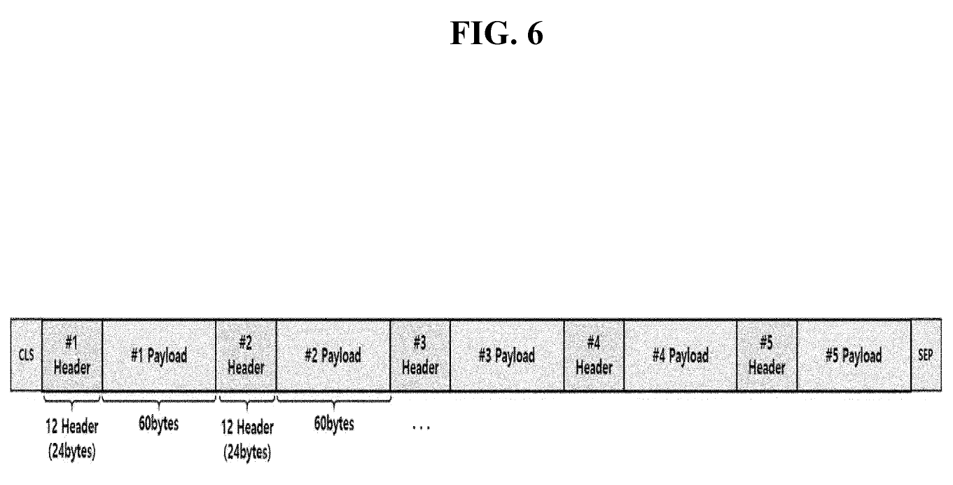

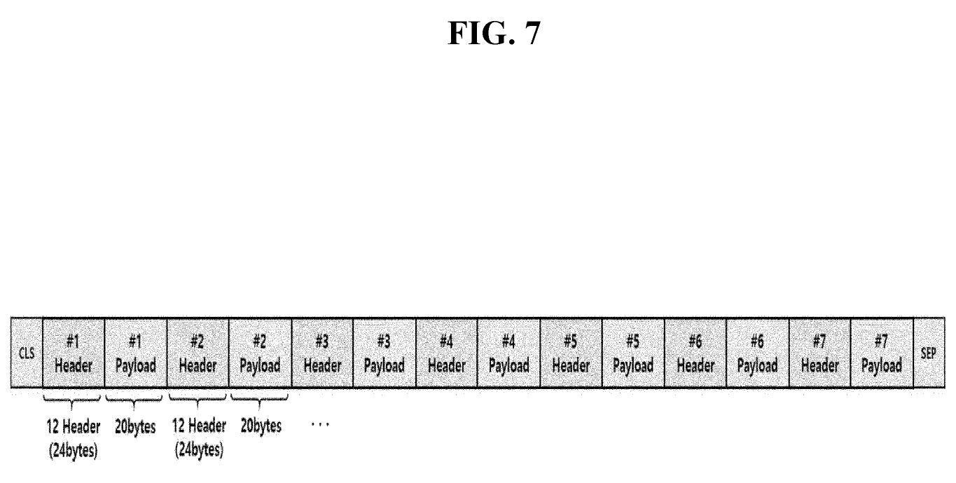

FIGS. 6 and 7 illustrate a dataset composed of multimodal feature information for each flow according to an embodiment of the present invention.

Referring to FIGS. 6 and 7, the multimodal features extracted for each packet can be organized into a single dataset (or sentence, sequence) for pre-training and fine-tuning of the BERT model.

Referring to FIGS. 6 and 7, a field named CLS may be added before the header of the first packet, and a field named SEP may be added after the payload of the last packet (the 5th packet in FIG. 6 and the 7th packet in FIG. 7). In the BERT model, various special tokens are defined and used to support the tokenization of input data (words, values of each header field in the present invention, etc.) and to model relationships between sentences. That is, in the pre-training and fine-tuning (or inference) stages of attack (abnormal behavior) detection and application classification models, the language model BERT processes the input sequence, and first, ‘CLS’ signifies the start of a sentence (sequence), ‘MASK’ is used to represent individual tokens, and ‘PAD’ signifies a padding token. The present invention may also include tokens that can be utilized to systematically structure the input sequence in the BERT model, even if not otherwise described.

Referring to FIGS. 6 and 7, multimodal features form a sentence in the order of header information and payload of n packets constituting a flow. That is, multimodal feature information (header information and payload) for each of n packets can be sequentially connected to generate a dataset (or sentence, sequence). However, this is merely one example, and the dataset (or sentence, sequence) may be generated differently depending on the purpose of detecting attacks (abnormal behavior) in cryptographic traffic or classifying by application. For example, a dataset (or sentence, sequence) for pre-training and fine-tuning a BERT model may be constructed by placing the header field portion of the n packet at the beginning of the sequence and then sequentially placing k-byte payloads thereafter. That is, the header field for each of n packets is sequentially connected, and subsequently, the k-byte payload for each of n packets is sequentially connected to generate a dataset (or sentence, sequence).

The present invention provides a method and apparatus structure capable of performing pre-training based on BERT, a representative language model in the AI field, with n-packets of header field information and k-packets of payload information selected at the flow level in encrypted traffic, and fine-tuning to perform attack (abnormal behavior) detection or application-specific classification in encrypted traffic as described as an example of the purpose.

According to the present invention, instead of using only metadata of a fixed size (length) per single packet or only payloads of a fixed length within a flow, the number of packets included in the flow and the payloads included in these packets are extracted and generated in various ways as k-bytes. This allows for the improvement of the generalization capability of the attack (abnormal behavior) detection or application-specific classification model using sentences (sequences) composed of multimodal features containing unique patterns or identification information inherent in attack behaviors, application-specific handshake processes, and cryptographic protocol negotiation processes, and enables adaptive utilization in actual network environments. Furthermore, by pre-training the BERT model with a multimodal feature dataset composed of various sizes and lengths, and fine-tuning it for attack detection, malicious behavior detection, or application-specific classification depending on the purpose, it can be utilized to improve the accuracy of real-time attack (anomaly) detection and reduce false positive rates, as well as enhance the real-time classification and prediction of encrypted traffic by application.

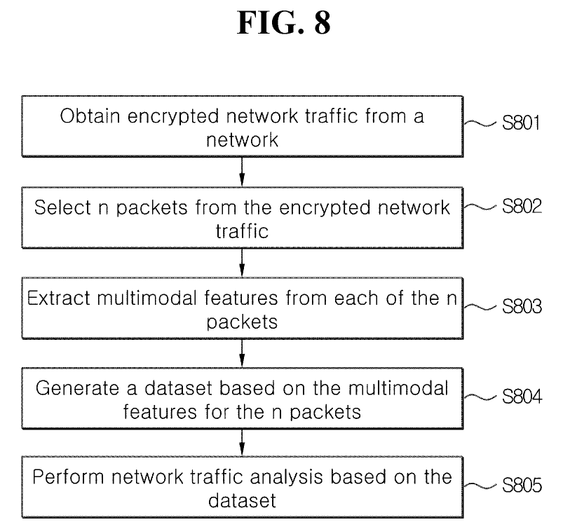

FIG. 8 illustrates a method for analyzing network traffic according to an embodiment of the present invention.

Referring to FIG. 8, a network traffic device (system) acquires (collects) encrypted network traffic from a network (S801).

The network traffic device (system) selects n packets (where n is an integer greater than 0) per flow from the encrypted network traffic (S802).

Here, the network traffic device (system) may select n packets (where n is an integer greater than 0) per flow or per session. Whether to select n packets (where n is an integer greater than 0) per flow or per session may be determined variably based on the settings for analyzing network traffic.

In addition, the network traffic device (system) may select n packets that are initially (i.e., first) generated per session or per flow.

A network traffic device (system) extracts multi-modal feature information from each of n packets (S803). Here, the multi-modal feature information may include one or more header fields (i.e., metadata) and a payload of k bytes (where k is an integer greater than 0).

Here, the values of n and k may be variably determined based on the settings for analyzing network traffic.

For example, the above one or more header fields may include at least one of IP version, IP header length, IP type of service (TOS), IP fragment offsets, IP protocol, TCP offset, TCP flags, TCP window, TCP urgent pointer, and UDP length. Additionally, the value of the 5-tuple, TCP protocol Sequence Number field may not be extracted.

A network traffic device (system) generates a dataset based on multimodal feature information for n packets (S804).

Here, as described above, the network traffic device (system) can generate a dataset based on multimodal feature information for n packets selected per flow or session.

For example, the above dataset may be generated by sequentially concatenating the multimodal feature information for each of the n packets. As another example, the above dataset may be generated by sequentially concatenating one or more header fields for each of the n packets, followed by sequentially concatenating the k-byte payloads for each of the n packets.

In addition, when generating the above dataset, the payload portion of packets without a payload among the n packets may be zero-padded so that the length of the multimodal feature information for each of the n packets is maintained to be the same.

The network traffic device (system) performs an analysis of network traffic based on the dataset (S805).

Here, the network traffic device (system) can pre-train an analysis model for analyzing the network traffic using the dataset, and fine-tune the analysis model according to the type of analysis of the network traffic to perform analysis of the network traffic.

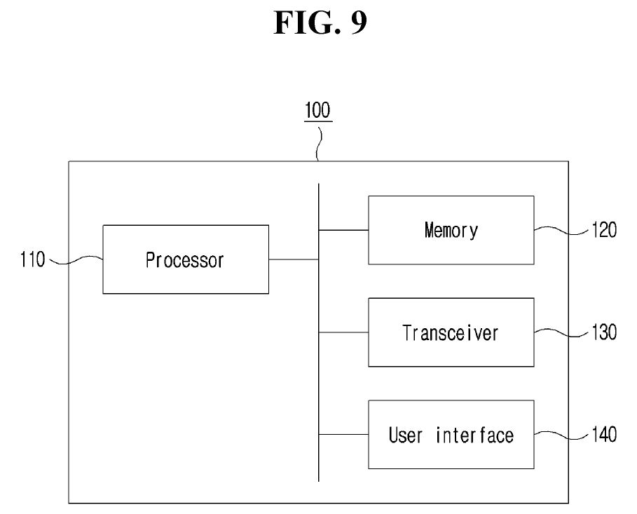

FIG. 9 is a block diagram of a network traffic analysis device according to one embodiment of the present invention.

Referring to FIG. 9, a network traffic analysis device (100) may include one or more processors (110), one or more memories (120), one or more transceivers (130), one or more user interfaces (140), etc. The memory (120) may be included in the processor (110) or configured separately. The memory (120) may store instructions that cause the device (100) to perform an operation when executed by the processor (110). The transceiver (130) may transmit and/or receive signals, data, etc., that the device (100) exchanges with other entities. The user interface (140) may receive user input regarding the device (100) or provide the output of the device (100) to the user. Among the components of the device (100), components other than the processor (110) and memory (120) may not be included depending on the case, and other components not shown in FIG. 9 may be included in the device (100).

Referring to FIG. 9, the network traffic analysis device (100) may include one or more processors (110), one or more memories (120), one or more transceivers (130), and one or more user interfaces (140). The processor (110) may be configured to enable the aforementioned device (100) to perform methods according to various examples of the present disclosure. Although not illustrated in FIG. 9, the processor (110) may be configured as a set of modules that perform each of the methods/functions proposed in the present disclosure. The modules may be configured in the form of hardware and/or software.

The processor (110) obtains (collects) encrypted network traffic from the network.

The processor (110) selects n packets (where n is an integer greater than 0) per flow from the encrypted network traffic.

Here, the processor (110) may select n packets (where n is an integer greater than 0) per flow or per session. Whether to select n packets (where n is an integer greater than 0) per flow or per session may be determined variably based on the settings for analyzing network traffic.

Additionally, the processor (110) may select n packets that are initially (i.e., first) generated for each session or flow.

The processor (110) extracts multi-modal feature information from each of the n packets. Here, the multi-modal feature information may include one or more header fields (i.e., metadata) and a payload of k bytes (where k is an integer greater than 0).

Here, the values of n and k may be variably determined based on the settings for analyzing network traffic.

For example, the above one or more header fields may include at least one of IP version, IP header length, IP type of service (TOS), IP fragment offsets, IP protocol, TCP offset, TCP flags, TCP window, TCP urgent pointer, and UDP length. Additionally, the 5-tuple, the Sequence Number field value of the TCP protocol may not be extracted.

The processor (110) generates a dataset based on multimodal feature information for n packets.

Here, as described above, the processor (110) can generate a dataset based on multimodal feature information for n packets selected per flow or session.

For example, the dataset may be generated by sequentially concatenating the multimodal feature information for each of the n packets. As another example, the dataset may be generated by sequentially concatenating one or more header fields for each of the n packets, followed by sequentially concatenating the k-byte payloads for each of the n packets.

In addition, when generating the above data set, the payload portion of the packet without a payload among the n packets is zero-padded, so that the length of the multi-modal feature information for each of the n packets can be maintained equally.

The processor (110) performs an analysis of network traffic based on the data set.

Here, the processor (110) can pre-train an analysis model for analyzing network traffic using the dataset and fine-tun the analysis model according to the type of analysis of network traffic to perform analysis of network traffic.

Components described in exemplary embodiments of the present disclosure may be implemented by hardware elements. For example, the hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in exemplary embodiments may be implemented in a combination of hardware and software.

The method according to an embodiment of the present disclosure may be implemented as a program that can be executed by a computer, and the computer program may be recorded in various recording media such as magnetic storage media, optical read media, and digital storage media.

The various technologies described in this disclosure may be implemented as digital electronic circuits or computer hardware, firmware, software, or a combination thereof. The above technologies may be implemented as a computer program product, that is, a computer program tangibly embodied in an information medium (e.g., a machine-readable storage device (e.g., a computer-readable medium) or a data processing device) or a computer program implemented as signals processed by or propagated by a data processing device to cause the operation of the data processing device (e.g., programmable processor, computer, or multiple computers).

Computer program(s) may be written in any form of programming language, including compiled or interpreted languages and may be distributed as a stand-alone program or in any form, including modules, components, subroutines, or other units suitable for use in a computing environment. A computer program may be executed by a single computer or by multiple computers distributed at one site or multiple sites and interconnected by a communications network.

Examples of processors suitable for executing computer programs include general-purpose and special-purpose microprocessors, and one or more processors in digital computers. Typically, a processor receives instructions and data from read-only memory, random access memory, or both. Components of a computer may include at least one processor for executing instructions and one or more memory devices for storing instructions and data. Additionally, the computer may include one or more mass storage devices for data storage, such as magnetic, magneto-optical disks, or optical disks, or may be connected to the mass storage devices to receive and/or transmit data. Examples of information media suitable for implementing computer program instructions and data include optical media such as semiconductor memory devices (e.g., magnetic media such as hard disks, floppy disks, and magnetic tapes), compact disk read-only memory (CD-ROM), digital video disk (DVD), etc., magneto-optical media such as floptical disks, and read only memory (ROM), random access memory (RAM), flash memory, erasable programmable ROM (EPROM), electrically erasable programmable ROM (EEPROM), and other known computer-readable media. Processors and memories can be supplemented or integrated by special-purpose logic circuits.

A processor may run an operating system (OS) and one or more software applications that run on the OS. The processor device may also access, store, manipulate, process and generate data in response to software execution. For simplicity, the processor device is described in the singular, but those skilled in the art will understand that the processor device may include a plurality of processing elements and/or various types of processing elements. For example, a processor device may include a plurality of processors or a processor and a controller. Additionally, different processing structures, such as parallel processors, may be configured. Additionally, computer-readable media refers to all media that a computer can access, and may include both computer storage media and transmission media.

Although this disclosure includes detailed descriptions of various detailed implementation examples, the details should not be construed as limiting the invention or scope of the claims proposed in this disclosure, but rather illustrating features of specific exemplary embodiments.

Features individually described in exemplary embodiments in this disclosure may be implemented by a single exemplary embodiment. Conversely, various features described in this disclosure with respect to a single exemplary embodiment may be implemented by a combination or appropriate sub-combination of a plurality of exemplary embodiments. Furthermore, in the present disclosure, the features may operate by a specific combination, and the combination may initially be described as claimed, however, in some cases, one or more features may be excluded from the claimed combination, or claimed combinations may be modified in the form of sub-combinations or modifications of sub-combinations.

Similarly, even if operations are depicted in a specific order in the drawings, it should not be understood that execution of the operations in a specific order or sequence is necessary, or that performance of all operations is required to obtain a desired result. In certain cases, multitasking and parallel processing can be useful. Additionally, it should not be understood that the various device components in all exemplary embodiments are necessarily separate, and the above-described program components and devices may be packaged in a single software product or multiple software products.

The exemplary embodiments disclosed herein are illustrative only and are not intended to limit the scope of the disclosure. Those skilled in the art will recognize that various modifications may be made to the exemplary embodiments without departing from the scope of the claims and their equivalents.

Accordingly, this disclosure is intended to include all other substitutions, modifications and changes that fall within the scope of the following claims.

What is claimed is:

1. A method for analyzing network traffic, the method comprising:
obtaining encrypted network traffic from a network;
selecting n packets (n is an integer greater than 0) from the encrypted network traffic;
extracting multi-modal feature information from each of the n packets, wherein the multi-modal feature information includes one or more header fields and a k-byte payload (k is an integer greater than 0);
generating a dataset based on the multi-modal feature information for the n packets; and
performing an analysis of the network traffic based on the dataset.

2. The method of claim 1, wherein a value of the n and a value of the k are determined based on a configuration for analyzing traffic of the network.

3. The method of claim 1, wherein the dataset is generated by sequentially concatenating the multi-modal feature information for each of the n packets.

4. The method of claim 1, wherein the dataset is generated by sequentially concatenating one or more header fields for each of the n packets, and subsequently concatenating the k-byte payloads for each of the n packets.

5. The method of claim 1, wherein the n packets are selected per session or flow.

6. The method of claim 5, wherein the n packets initially generated per the session or the flow are selected.

7. The method of claim 1, wherein, in generating the dataset, the multi-modal feature information for each of the n packets has same length by zero-padding for a payload portion of a packet without a payload among the n packets.

8. The method of claim 1, wherein the one or more header fields comprise at least one of an internet protocol (IP) version, an IP header length, a type of service (TOS), an IP fragment offset, an IP protocol, a transmission control protocol (TCP) offset, TCP flags, a TCP window, a TCP urgent pointer, and a user datagram protocol (UDP) length.

9. The method of claim 1, wherein an analysis model for analyzing traffic of the network is pre-trained using the dataset, and the analysis model is fine-tuned according to a type of analyzing traffic of the network.

10. An apparatus for analyzing network traffic, the apparatus comprising:
at least one processor; and
at least one memory operably connected to the at least one processor and storing instructions that, when executed by the one or more processors, cause the apparatus to perform operations comprising:
obtaining encrypted network traffic from a network;
selecting n packets (n is an integer greater than 0) from the encrypted network traffic;
extracting multi-modal feature information from each of the n packets, wherein the multi-modal feature information includes one or more header fields and a k-byte payload (k is an integer greater than 0);
generating a dataset based on the multi-modal feature information for the n packets; and
performing an analysis of the network traffic based on the dataset.

11. The apparatus of claim 10, wherein a value of the n and a value of the k are determined based on a configuration for analyzing traffic of the network.

12. The apparatus of claim 10, wherein the dataset is generated by sequentially concatenating the multi-modal feature information for each of the n packets.

13. The apparatus of claim 10, wherein the dataset is generated by sequentially concatenating one or more header fields for each of the n packets, and subsequently concatenating the k-byte payloads for each of the n packets.

14. The apparatus of claim 10, wherein the n packets are selected per session or flow.

15. The apparatus of claim 14, wherein the n packets initially generated per the session or the flow are selected.

16. The apparatus of claim 10, wherein, in generating the dataset, a same length of the multi-modal feature information for each of the n packets has same length by zero-padding for a payload portion of a packet without a payload among the n packets.

17. The apparatus of claim 10, wherein the one or more header fields comprise at least one of an internet protocol (IP) version, an IP header length, a type of service (TOS), an IP fragment offset, an IP protocol, a transmission control protocol (TCP) offset, TCP flags, a TCP window, a TCP urgent pointer, and a user datagram protocol (UDP) length.

18. The apparatus of claim 10, wherein an analysis model for analyzing traffic of the network is pre-trained using the dataset, and the analysis model is fine-tuned according to a type of analyzing traffic of the network.

19. At least one non-transitory computer-readable medium storing at least one instruction, wherein the at least one instruction executable by at least one processor controls an apparatus for analyzing network traffic to:
obtain encrypted network traffic from a network;
select n packets (n is an integer greater than 0) from the encrypted network traffic;
extract multi-modal feature information from each of the n packets, wherein the multi-modal feature information includes one or more header fields and a k-byte payload (k is an integer greater than 0);
generate a dataset based on the multi-modal feature information for the n packets; and
perform an analysis of the network traffic based on the dataset.
